(19) United States
(12) Patent Application Publication
(10) Pub. No.: US 2026/0354615 A1
(43) Pub. Date: Nov. 12, 2026

(54) INFUSION DEVICE FOR PREPARING BEVERAGES USING INSOLUBLE MATERIAL

(71) Applicant: PI-DESIGN AG, Baar (CH)

(72) Inventor: Jorgen Bodum, Küssnacht am Rigi (CH)

(21) Appl. No.: 19/134,670

(22) PCT Filed: Nov. 28, 2023
(86) PCT No.: PCT/EP2023/083390

§ 371 Date: May 30, 2025

(30) Foreign Application Priority Data
Dec. 1, 2022 (DE) 10 2022 131 904.0

(51) Int. Cl. A47J 31/20; A47J 31/44

(52) U.S. Cl. CPC A47J 31/20; A47J 31/4403

(57) ABSTRACT

The present invention relates to an infusion device (10) for preparing beverages using insoluble material, comprising a vessel (12) for receiving the beverage and the insoluble material having an open end (26) and a closed end (28) and defining an axis (X), and a piston-filter assembly (30) insertable into the vessel (12) via the open end (26) and movable towards the closed end (28) along the axis (X), the piston-filter assembly (30) comprising a filter element (36) and a sealing section (38), wherein the sealing section (38) encloses the filter element (36) radially outwardly with reference to the axis (X) and seals the piston-filter assembly (30) against the vessel (12), and comprises a first sealing gasket (46) and a second sealing gasket (48) being arranged spaced from each other with reference to the axis (X).

The present invention relates to an infusion device for preparing beverages using insoluble material.

Infusion devices for preparing beverages are also called French presses or press filters. The infusion device has a vessel with an open end and a closed end, whereby the vessel usually has a cylindrical or prismatic shape. To prepare a beverage, typically coffee or tea, the desired amount of insoluble material such as coffee powder or tea leaves is poured into the vessel via the open end and then hot water is poured over it. Then, the coffee powder or tea leaves are allowed to be extracted for a certain period of time. Thereafter, a piston-filter assembly is placed in the container, which includes a piston rod and a filter element attached to the piston rod. Typically, the piston rod is slidably mounted in a lid that can be fitted over the open end and used to close the vessel. The press filter has a shape corresponding to the cross-section of the vessel, so that the filter element is laterally flush with the vessel. The filter element is pressed towards the closed end of the vessel by means of the piston rod. As a result, the extracted coffee powder or tea leaves are separated from the coffee or tea and compressed in the area of the closed end. The coffee or tea filtered in this way can now be consumed. After the coffee or tea has been fully consumed, the piston-filter assembly is withdrawn from the container and the compressed coffee powder or tea leaves are removed from the container. Documents showing the relevant prior art include DE 34 32 289C1, WO 02/067739 A1, U.S. Pat. No. 10,791,866 B2, EP 2 798 985 A1, EP 3 242 579 B1, U.S. Pat. No. 11,109,707 B2 and WO 96/035360 A1.

To ensure a sufficient separation of the insoluble material from the beverage, the piston-filter assembly is equipped with a sealing member by which the piston-filter assembly is sealed against the inner wall surface of the vessel. However, it has been found that a proper sealing of the piston-filter assembly against the vessel is not an easy task. As noted above, the piston-filter assembly is moved downwards towards the closed end. This movement may be impaired in case the contacting pressure between the sealing member and the vessel is too high. If the vessel is made of glass, there may be the risk that the vessel is damaged by the contacting pressure. The higher the contact pressure, the higher the wear of the sealing member leading to a premature loss or decrease of the sealing function. When the contacting pressure is too low, the separation of the insoluble material from the beverage may be insufficient. The insufficient separation may be aggravated by tolerance deviations of the vessel and by relaxation of the sealing member.

The task of one embodiment of the present invention is to propose an infusion device for preparing beverages using insoluble material by which the disadvantages described above can be improved. In particular, the present invention seeks to propose an infusion device having a piston-filter assembly which is easy to move inside the vessel and provides a long-term and sufficient separation of the insoluble material from the beverage.

This task is solved with the features indicated in claim 1. Advantageous embodiments are the subject of the sub-claims.

One embodiment of the invention relates to an infusion device for preparing beverages using insoluble material, comprising
a vessel for receiving the beverage and the insoluble material, the vessel having an open end and a closed end and defining an axis, and
a piston-filter assembly insertable into the vessel via the open end and movable toward the closed end along the axis,
the piston-filter assembly comprising a filter element and a sealing section, wherein the sealing section
   encloses the filter element radially outwardly with reference to the axis and seals the piston-filter assembly against the vessel, and
   comprises a first sealing gasket and a second sealing gasket being arranged spaced from each other with reference to the axis.

The first sealing gasket and the second sealing gasket can be formed by a common sealing member, however, the first sealing gasket and the second sealing may be individual parts and separately connected to the filter-piston assembly.

Insoluble material not separated from the beverage by the second sealing gasket may be separated by the first sealing gasket. The separation is improved even at reduced contact pressure. When the contact pressure is reduced, the wear is also reduced such that the improved separation is maintained for a longer time.

According to a further embodiment
the first sealing gasket has a first radial extension with reference to the axis and
the second sealing gasket has a second radial extension with reference to the axis,
the first radial extension being different from the second radial extension.

In many cases the vessel has a circular cross section. In this case the first radial extension and the second radial extension can be considered as diameters. As the first radial extension is different from the second radial extension, the first sealing gasket may exert a different contact pressure to the vessel than the second sealing gasket. The separation can be improved without compromising the movability of the piston-filter assembly inside the vessel.

In a further embodiment
the first sealing gasket has a first thickness and
the second sealing gasket has a second thickness,
the first thickness being different from the second thickness.

The flexibility of the first sealing gasket and the second sealing gasket can be adjusted by the first thickness and the second thickness, respectively. As initially explained, the infusion device may be used in particular for the preparation of coffee and tea. However, the particle size of coffee powder is usually smaller than the particle size of tea leaves. The use of sealing gaskets having a different flexibility ensures a proper separation regardless of the type of insoluble material used and its concentration.

According to a further embodiment
the first sealing gasket is arranged in front of the second sealing gasket seen from the open end and along the axis, and
the first radial extension is bigger than the second radial extension and the first thickness is smaller than the second thickness.

It has been turned out that in this embodiment a high separation degree can be obtained, and a stick-slip effect can be avoided.

In a further embodiment the vessel has a radial vessel extension with reference to the axis, the radial vessel extension changing along the axis.

As noted above, in most cases the vessel has a circular cross section. Thus, the radial vessel extension can also be considered as the diameter of the vessel. The changing radial vessel extension may be caused by tolerance deviations, in particular when the vessel is made of glass, or may be intended due to design or technical reasons. As the piston-filter assembly comprises two sealing gaskets, it is possible to adjust them to the changing radial vessel extension, thereby safeguarding the proper separation even in case of a changing radial vessel extension.

According to a further embodiment
the vessel comprises a first container and a second container connected to each other and forming an intermediate space,
the sealing section sealing the piston-filter assembly against the first container.

The intermediate space is usually hermetically closed and filled with air which acts as an insulation. As initially noted, the infusion device is primarily used for the preparation of hot beverages such as coffee or tea. Due to the insulating properties of the intermediate space the temperature of the beverage is maintained for a longer time compared to single-walled vessels. The first container is enclosed by the second container and the beverage is received by the first container. Thus, the sealing section interacts with the first container.

In a further embodiment the first container has a radial first container extension with reference to the axis, the radial first container extension changing along the axis. In particular for design reasons it may be desirable to provide in particular the first container with a changing diameter. Again, the first sealing gasket and the second sealing gasket can be designed such that a proper separation of the infusible material from the beverage is possible despite the changing diameter of the first container.

According to a further embodiment the first container and/or the second container are made of plastic. The use of plastic offers the possibility to produce the first container and the second container in large quantities at acceptable costs in particular in case the first container and the second container are produced by injection molding. For facilitating the demolding, a diameter slightly increasing from the closed end to the open end is beneficial. As already explained, changing diameters can be adjusted by the first sealing gasket and the second sealing gasket to ensure proper separation of the insoluble material.

In a further embodiment the infusion device further comprises
a lid which is insertable into the open end of the vessel and which comprises a guide bore running parallel to the axis, wherein
the piston-filter assembly comprises a piston rod to which the filter element is fastened,
the piston rod being passed through the guide bore.

The lid can be used for temporarily closing the open end such that heat losses may be minimized such that the initial temperature of the beverage is maintained for a longer time. Moreover, an unintentional spill of the beverage upon pouring the beverage into a tea or coffee cup is prevented. The guide bore also prevents a twist of the piston-filter assembly inside the vessel, thereby safeguarding a proper separation of the insoluble material from the beverage.

Exemplary embodiments of the invention are explained in more detail below with reference to the accompanying drawings.

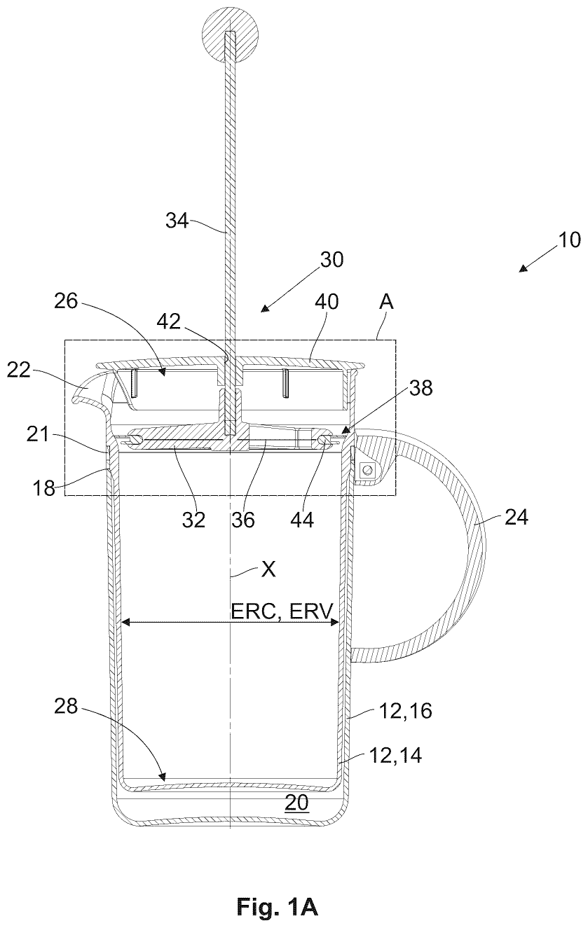

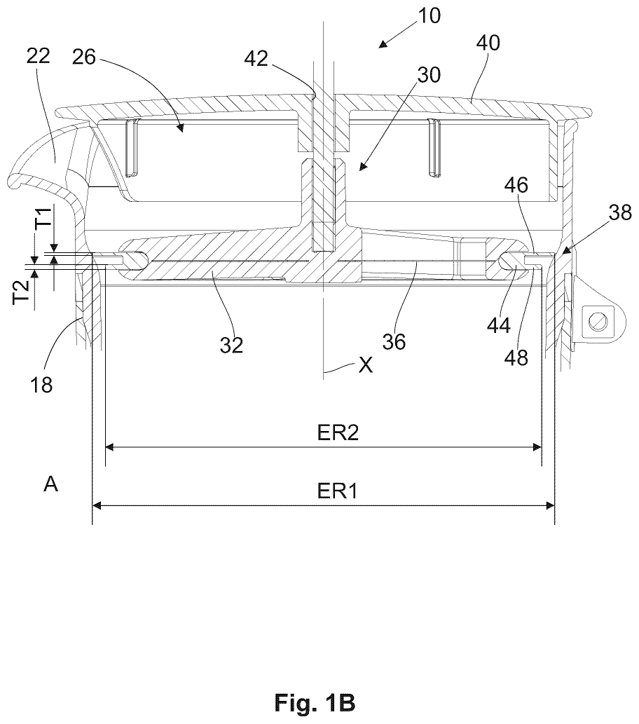

FIG. 1A shows a sectional view of an embodiment of an infusion device according to the present invention with a piston-filter assembly in a first position,

FIG. 1B is an enlarged detail of the area A defined in FIG. 1A,

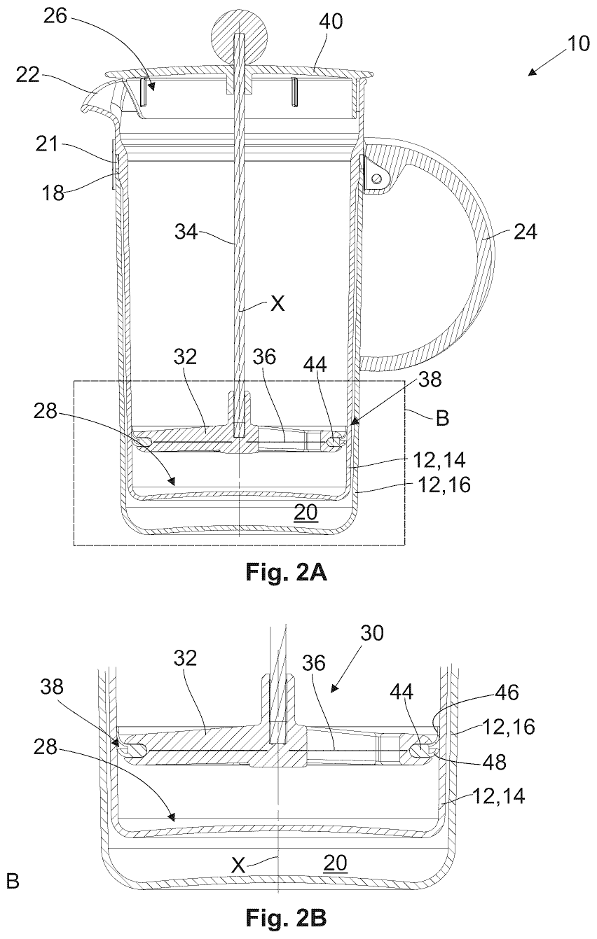

FIG. 2A shows a sectional view of an embodiment of an infusion device according to the present invention with a piston-filter assembly in a second position, and

FIG. 2B is an enlarged detail of the area B defined in FIG. 2A.

In FIG. 1A an embodiment of an infusion device 10 according to the present invention is shown by means of a sectional view. The infusion device 10 according to the embodiment shown in FIG. 1A comprises a vessel 12 that is formed by a first container 14 and a second container 16. The first container 14 and the second container 16 are cylindrically shaped. The first container 14 is inserted into the second container 16 and arranged concentrically to the second container 16 with reference to an axis X. The first container 14 and the second container 16 are made of plastic and are fastened to each other in a connecting section 18. The first container 14 and the second container 16 may be connected to each other by a material bond such as welding or gluing or by other appropriate means. In the connected state the first container 14 and the second container 16 are enclosing an intermediate space 20 filled with air. The intermediate space 20 may be sealed by a vessel seal 21 to prevent an air exchange. The first container 14 forms a spout 22. A handle 24 is fastened to the second container 16.

The vessel 12, in this case the first container 14, forms an open end 26 and a closed end 28. A piston-filter assembly 30 is insertable into the first container 14 via the open end 26. The piston-filter assembly 30 comprises a disc-shaped holding frame 32 that is fastened to a piston rod 34. A filter element 36 is attached to the holding frame 32. Beyond that, an angularly shaped sealing section 38 is formed around the filter element 36.

A lid 40 is inserted into the open end 26 of the first container 14 and is provided with a guide bore 42 that runs concentrically to the axis X. The piston rod 34 is passed through the guide bore 42 and is thereby positioned concentrically to the axis X.

As in particular visible from FIG. 1B which is an enlarged view of the area defined in FIG. 1A, the sealing section 38 is formed by a sealing member 44 that encloses the filter element 36 and comprises a first sealing gasket 46 and a second sealing gasket 48. Seen from the open end 26 along the axis X the first sealing gasket 46 is arranged in front of the second sealing gasket 48. The first sealing gasket 46 has a first radial extension ER1 with reference to the axis X and the second sealing gasket 48 has a second radial extension ER2 with reference to the axis X. As mentioned, the first container 14 has a cylindrical shape. As the first sealing gasket 46 and the second sealing gasket 48 may seal the filter assembly against the first container 14, the first radial extension ER1 and the second radial extension ER2 can also be considered as diameters of the first sealing gasket 46 and the second sealing gasket 48, respectively.

As shown in FIG. 1A, the vessel 12 has a radial vessel extension ERV with reference to the axis X which is in this case formed by the first container 14 and also denominated as radial first container extension ERC. Both the radial vessel extension ERV and the radial first container extension ERC refer to the inner extension of the vessel 12 and the first container 14, respectively.

The radial vessel extension ERV and the radial first container extension ERC are changing along the axis X. Starting from the open end 26 the radial first container extension ERC1 is decreasing in an area between the spout 22 and the connecting section 18. The radial first container extension ERC then only slightly decreases towards the closed end 28.

The first radial extension ER1 of the first sealing gasket 46 is larger than the second radial extension ER2 of the second sealing gasket 48 (see FIG. 1B). Moreover, the first sealing gasket 46 has a first thickness T1 and the second sealing gasket 48 has a second thickness T2. The first thickness T1 is smaller than the second thickness T2.

The infusion device 10 is operated as follows: To prepare coffee or tea, the desired amount of insoluble material such as coffee powder or tea leaves is poured into the first container 14 via the open end 26 and then hot water is poured over it. Then, the coffee powder or tea leaves are allowed to be extracted for a certain period. Thereafter, the lid 40 together with the piston-filter assembly 30 are inserted into the open end 26 of the first container 14, as best seen in FIG. 1A. The holding frame 32 is abutting or almost abutting the lid 40 and the piston rod 34 is maximally or almost maximally protruding the lid 40 upwardly. As particularly evident from FIG. 1B, only the first sealing gasket 46 is in contact with the first container 14.

The piston-filter assembly 30 is now moved towards the closed end 28 of the vessel 12 by pressing the piston rod 34 downwards. As a result, the extracted coffee powder or tea leaves are separated from the coffee or tea and compressed in the area of the closed end 28 (see FIGS. 2A and 2B).

As mentioned, the radial first container extension ERC is decreasing along the axis X towards the closed end 28. As a result, not only the first sealing gasket 46 but also the second sealing gasket 48 are contacting the first container 14. Due to the larger first radial extension ER1 and the smaller first thickness T1 compared to the second radial extension ER2 and the second thickness T2, respectively, the first sealing gasket 46 is bent to a larger degree compared to the second sealing gasket 48 (FIG. 2B). The contacting area between the first sealing gasket 46 and the first container 14 is therefore larger than the contacting area between the second sealing gasket 48 and the first container 14. The further the sealing section 38 is moved towards the closed end 28 the higher the concentration of the insoluble material. The second sealing gasket 48 can keep the contact to the first container 14 even when the pressure exerted by the insoluble material on the second sealing gasket 48 is fairly high.

The coffee or tea filtered in this way can now be drunk. To this end, the infusion device 10 can be gripped by the handle 24 and tilted such that the beverage can leave the first container 14 via the spout 22. After the coffee or tea has been fully consumed, the piston-filter assembly 30 is withdrawn from the vessel 12 and the compressed coffee powder or tea leaves are removed from the vessel 12.

### REFERENCE LIST

10 infusion device
12 vessel
14 first container
16 second container
18 connecting section
20 intermediate space
21 vessel seal
22 spout
24 handle
26 open end
28 closed end
30 piston-filter assembly
32 holding frame
34 piston rod
36 filter element
38 sealing section
40 lid
42 guide bore
44 sealing member
46 first sealing gasket
48 second sealing gasket
A axis
ERC radial first container extension
ERV radial vessel extension
ER1 first radial extension
ER2 second radial extension
T1 first thickness
T2 second thickness

1. Infusion device (10) for preparing beverages using insoluble material, comprising
a vessel (12) for receiving the beverage and the insoluble material, the vessel (12) having an open end (26) and a closed end (28) and defining an axis (X), and
a piston-filter assembly (30) insertable into the vessel (12) via the open end (26) and movable towards the closed end (28) along the axis (X),
the piston-filter assembly (30) comprising a filter element (36) and a sealing section (38), wherein the sealing section (38)
encloses the filter element (36) radially outwardly with reference to the axis (X) and seals the piston-filter assembly (30) against the vessel (12), and
comprises a first sealing gasket (46) and a second sealing gasket (48) being arranged spaced from each other with reference to the axis (X).

2. Infusion device (10) according to claim 1, characterized in that
the first sealing gasket (46) has a first radial extension (ER1) with reference to the axis (X) and
the second sealing gasket (48) has a second radial extension (ER2) with reference to the axis (X),
the first radial extension (ER1) being different from the second radial extension (ER2).

3. Infusion device (10) according to claim 1, characterized in that
the first sealing gasket (46) has a first thickness (T1) and
the second sealing gasket (48) has a second thickness (T2),
the first thickness (T1) being different from the second thickness (T2).

4. Infusion device (10) according to claim 1, characterized in that
the first sealing gasket (46) is arranged in front of the second sealing gasket (48) seen from the open end (26) and along the axis (X), and
the first radial extension (ER1) is bigger than the second radial extension (ER2) and the first thickness (T1) is smaller than the second thickness (T2).

5. Infusion device (10) according to claim 1, characterized in that the vessel (12) has a radial vessel extension (ERV) with reference to the axis (X), the radial vessel extension (ERV) changing along the axis (X).

6. Infusion device (10) according to claim 1, characterized in that
the vessel (12) comprises a first container (14) and a second container (16) connected to each other and forming an intermediate space (20),
the sealing section (38) sealing the piston-filter assembly (30) against the first container (14).

7. Infusion device (10) according to claim 6, characterized in that the first container (14) has a radial first container extension (ERC) with reference to the axis (X), the radial first container extension (ERC) changing along the axis (X).

8. Infusion device (10) according to claim 1, characterized in that the first container (14) and/or the second container (16) are made of plastic.

9. Infusion device (10) according to claim 1, characterized in that the Infusion device (10) further comprises
a lid (40) which is insertable into the open end (26) of the vessel (12) and which comprises a guide bore (42) running parallel to the axis (X), wherein
the piston-filter assembly (30) comprises a piston rod (34) to which the filter element (36) is fastened,
the piston rod (34) being passed through the guide bore (42).
